(19) United States
(12) Patent Application Publication
(10) Pub. No.: US 2015/0156464 A1
(43) Pub. Date: Jun. 4, 2015

(54) AUTOMATIC CALIBRATION AND ORIENTATION SYSTEM FOR MOBILE SELF-ALIGNMENT MULTIDIMENSIONAL OBJECT DETECTION AND TRACKING

(71) Applicant: Jason Lee, Ontario (CA)

(72) Inventor: Jason Lee, Ontario (CA)

(21) Appl. No.: 14/512,261

(22) Filed: Oct. 10, 2014

Related U.S. Application Data
(60) Provisional application No. 61/889,305, filed on Oct. 10, 2013.

(51) Int. Cl. H04N 7/18; G06K 9/00

(52) U.S. Cl. CPC H04N 7/185; G06K 9/00476

(57) ABSTRACT

The objective of the system is to provide multidimensional object detection and tracking in a mobile, changing environment.

### RELATED APPLICATION

This application claims the benefit of priority to U.S. Provisional Application No. 61/889,305 filed Oct. 10, 2013.

### TECHNICAL FIELD

The disclosed technology relates to the field of a system of mobile multidimensional object detection and tracking platform that can be rapidly deployed in a randomly oriented and changing environment.

### DESCRIPTION OF BACKGROUND ART

One of the major constraints with multidimensional object detection and tracking is the dependence on alignment and fixed positioning. These constraints make it very difficult and expensive for companies to fully utilize the power of multidimensional systems. Conventional multidimensional tracking systems are configured with the known positions of at least two sensor locations. These two known variables are critical to determining the spatial placement of an object in relation to the sensors. Using standard Euclidean geometry, the conventional system can calculate the 3D parameters of an object. One of the deficiencies of the conventional system is the requirement for a fixed platform and the ability for multiple systems to work simultaneously in an adhoc environment.

### SUMMARY

Automatic Calibration and Orientation System (ACOS) enables accurate object detection, recognition and tracking in a mobile environment. ACOS is a mobile, multidimensional object detection and tracking system that can be deployed in an unstructured environment. Similar to conventional systems, ACOS uses standard geometry to calculate an object's 3D parameters including position, height, width and length, direction, speed and acceleration. Unlike with conventional systems, ACOS does not need the exact location of the other sensors. ACOS generates spatial coordinates and instructions that are shared between all sensors in the immediate area. As each sensor receives their instructions they begin searching for the object and each other. Once they locate the object and each other, they can complete the multi-dimensional calculations. Various objects, features, aspects and advantages of the inventive subject matter will become more apparent from the following detailed description of preferred embodiments, along with the accompanying drawings in which like numerals represent like components.

ACOS can be used to detect and track jets as they are being moved around a hangar or ramp with the purpose of preventing collisions by providing early warning alarms.

ACOS can be used to detect and track objects including motorized vehicles, aircraft, people and animals whether they are moving or stationary.

ACOS can be used to accurately control unmanned aerial vehicles without the assistance of global positioning satellites (GPS). Practical applications are local area reconnaissance, flight controls and landing on any platform including aircraft carriers and other unstable platforms.

### DESCRIPTION OF THE DRAWINGS

FIG. 1 is an embodiment of the automatic calibration and orientation system for mobile self-alignment multidimensional object detection and tracking;

FIG. 2 is perspective view of two ACOS capable cones positioned in proximity to a jet located on a tarmac;

FIG. 3 is a block diagram of the components required for an embodiment of the ACOS system; and

FIG. 4 is an embodiment of the ACOS system positioned within a cylinder.

### DETAILED DESCRIPTION

ACOS accomplishes accurate object detection, recognition and tracking in a mobile environment by collecting and fusing data from a variety of sensors. The sensor data is collected and stored in an embedded SQL database or databases in a small mobile appliance that can be easily moved. The unique advantage of ACOS is the ability to provide 3D tracking from an unstable platform. This means that if the appliance is moved, twisted or tilted. The sensors will detect the movement and the software will automatically correct the appliances internal position without losing the real world position of the subject or object that it has been tracking.

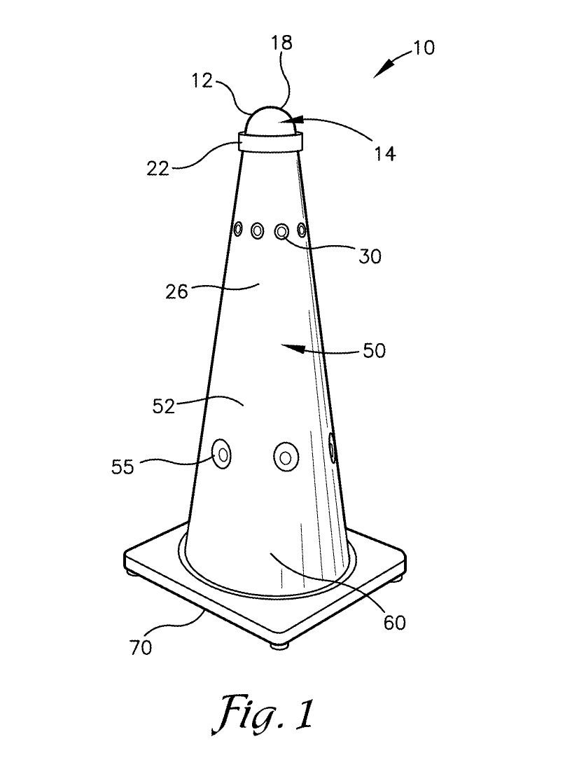

In a preferred embodiment of the disclosed technology as seen in FIG. 1, the technology is a multi-dimensional detection system with integrated alarming options. The ultimate purpose of the disclosed technology is to provide accurate location information, close proximity warning and object recognition and detection in a specific region for a number of applications including large vehicular parking such as jets, buses, boats, trains, cars and of people.

The ACOS system uses parallel processing to accelerate and maximize efficiency in data collection. The parallel processing occurs between the cameras and the sensors system. ACOS connects the camera in two ways. First, the camera is directly linked to the main fusion server. The initial link to the camera is preserved in its original state. Preservation in an original state is done so that at any time forensics investigators can access the untouched, unprocessed information in the event that a legal proceeding requires the data or new standards are developed. This linking to the main fusion server also provides instant “on-site” alarming without disrupting existing recording systems like Digital Video Recorders. It also enables each feed to be used in multiple systems. Whereas the image data is processed for alarm initiation, forensic analysis and archiving of data and the object's spatial coordinates and/or trajectory can be transmitted to one or more ACOS appliances or other cameras on the network.

Second, in an alternative configuration, the camera is linked directly to the sensor board and then to the main fusion server. The main fusion server is located at the center of the network and is designed to collect the information from all devices in the network. The primary function of the server is to fuse all of the information for intelligence development and to provide total situational awareness. The secondary function of the server is to send rules and instructions to each device in the network. Finally, the main fusion server acts as an archiving server for long term data storage and recall.

The camera is connected to the sensor board that resides within the tube enclosure under the camera. The sensor board consists of a multi-core process, multi-core graphics processor unit and multiple I/O ports for analog and digital sensors. The embedded software collects object information from the image and from the various sensors. This computer processes each data stream (camera stream, individual sensor stream, etc.) individually and fuses snipets or parts of the data stream as per the instructions provided by the user. In order to reduce processing time and conserver bandwidth, the process is completed at the location of each device or camera. The information gathered is typically small amounts of data that effectively describe an object's characteristics, behaviors, movements and location. This information is then sent directly to the main fusion server for processing, alarming, forensics, and archiving.

ACOS preferably utilizes a wide-angle view internet protocol video camera (ACOS will also support conventional directional internet protocol cameras, analog cameras need to be converted to internet protocol streams using standard internet protocol video converters). The wide-angle view can be as much as 180 degrees and capture a full hemisphere of visual data. The wide-angle optics introduces distortion into the captured image and processing algorithms operating on image processing circuitry correct the distortion and converts it to a view analogous to a mechanical pan-tilt-zoom camera. This flexibility to control and vary the captured views by data processing can be thought of as implementing one or more virtual cameras, each able to be independently controlled, by processing captured image data from the single optical system, or even a combination of several optical systems, to emulate one or more pan-tilt-zoom cameras.

ACOS also utilizes at least one of a multi-axis accelerometer or gyroscope; an electronic compass; an optional global positioning satellite (GPS) tracking device can be used to translate the ACOS location information to GPS coordinates for wide area geo-mapping. ACOS provides accurate location information using multiple sensors independent of conventional GPS. Sensor data is collected and stored using a common format to ensure ease of use and application flexibility.

As regards the process, ACOS creates a grid on a video stream and collects real time data from the electronic compass and a multi-axis accelerometer and fuses the data on the camera video stream. ACOS senses any movements or vibrations from its own position and constantly configures and aligns the position of the video image. ACOS then prepares the local database in each ACOS appliance for fusion, storage and archiving. ACOS detects an object and instantly displays any available sensor data on the image and then shares the detection data and relative position data with all other ACOS systems in the area. ACOS then stores the data in a central server for forensics analysis later.

FIG. 1 depicts an embodiment of the ACOS Appliance system 10 in a modified roadside cone. The function of the Appliance system is to provide accurate location information, close proximity warning and objection recognition and detection in a specific region for a number of applications including large vehicular parking such as jets, buses, boats, trains, cars as well as people and animals. The Appliance 12 is intended to include the following components: 1) a 360 degree (horizontal sweep) camera 18, 2) acrylic lens cover 14 (to protect the lens of the camera from scratching and inadvertent damage), 3) a lens cover nut 20 (to facilitate removal and replacement of the camera as needed), 4) a camera mount assembly 22, 5) multiple strands of multi-colored light emitting diodes LED 30, to signal to humans in proximity to the Appliance that the unit is properly functioning or in need of attention depending upon the coloration and sequencing of the light array, 6) an onboard computer system 46 to process the incoming data from the camera and the sensor array that will be discussed below, 7) an internal electronics stem 50 to facilitate the transmission of data between the Appliance components, 8) a wireless system 52 to communicate with a distantly located server and database, 9) at least one sensor 55 to include ultrasound sensing or passive infrared, for example, 10) a power supply 60 such as a battery with a solar charging controller, and 11) an electronics access panel 70.

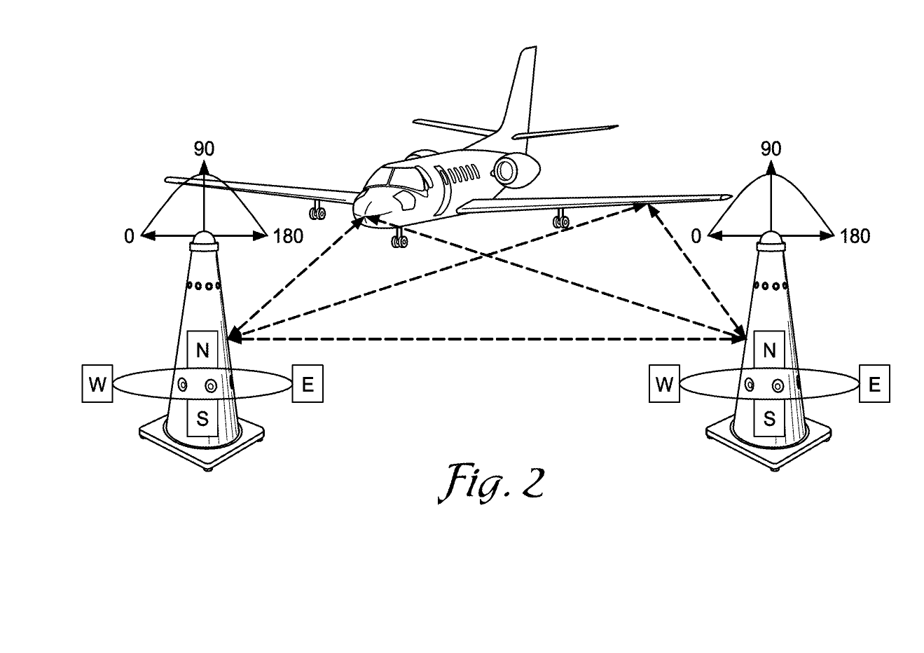

FIG. 2 depicts a single embodiment of two ACOS Appliances, as described immediately above, in proximity to a parked aircraft. This Appliances embodiment utilizes a sensory array including a 360 degree (horizontal sweep) camera along with ultrasound sensing or passive infrared to name just a few possible options for sensor hardware that may be employed. The ACOS Appliances track the location and movement of the aircraft while it is on the ramp and can provide the necessary updates to the fixed base operator (FBO) so that the operator is aware of where all aircraft under his jurisdiction and control are parked. Moreover, during movement of the aircraft by ground personnel any potential for collision with other solid objects can be averted. The Appliance design is rugged due to the resilient outer plastic cone casing that can attenuate impact loading from external sources to increase the survivability of the interior electronic components. The Appliance design is highly recognizable and when colorized with orange, red or yellow, for example can be readily seen and retrieved from anywhere on the tarmac, rail yard or other highly congested location.

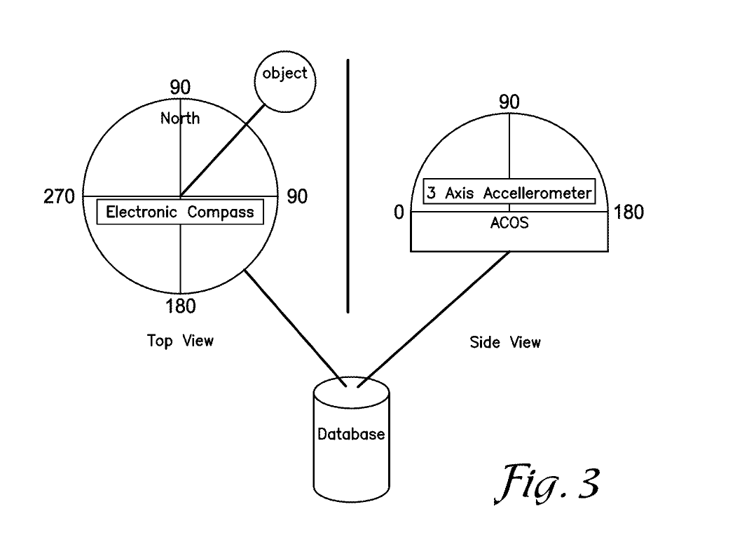

FIG. 3 is a block diagram of the ACOS Appliance 12 detailing the system components. The 360 degree horizontal sweep and hemispheric span of the digital camera 18 is coupled with a multi-axis accelerometer and an electronic compass in order to track the movement, speed and acceleration of an object. The digital data stream is fed to a server and stored in a database or compared against other objects within the data base for analysis. Depending upon the relative movements of the objects being tracked the system can initiate varying levels of alarms should some collision appear to be imminent or objects speeds exceed a preset level, for example.

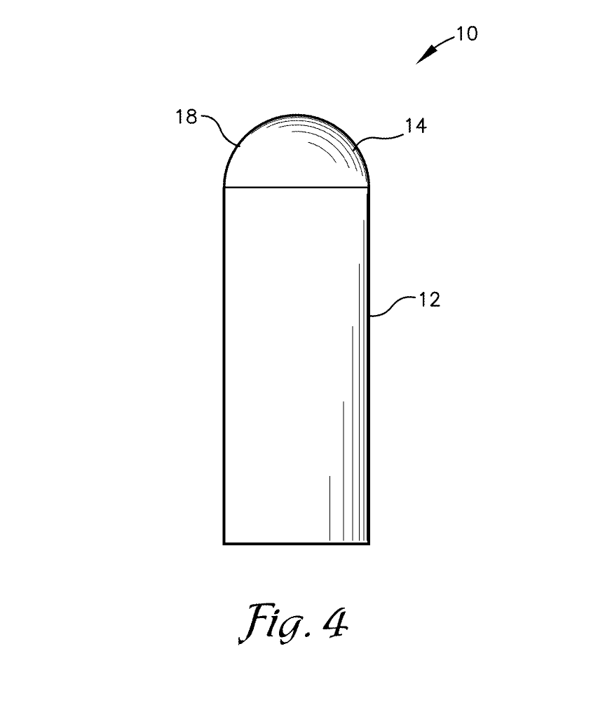

FIG. 4 is an alternative embodiment of an ACOS appliance 12 configured to fit within a nominal diameter, approximately 3 inches, container. The appliance can be deployed alone or installed in any shaped such as a standard 35 inch tarmac cone.

While the preferred form of the present invention has been shown and described above, it should be apparent to those skilled in the art that the subject invention is not limited by he figures and that the scope of the invention includes modifications, variations and equivalents which fall within the scope of the attached claims. Moreover, it should be understood that the individual components of the invention include equivalent embodiments without departing from the spirit of this invention.

It will be understood that certain features and subcombinations are of utility and may be employed without reference to other features and subcombinations and are contemplated within the scope of the claims. Not all steps listed in the various figures need be carried out in the specific order described.

I claim:

1. A system for detecting, recognizing and tracking objects in three dimensional space, the system comprising:
a main fusion server;
at least one of 1) a multi-axis accelerometer, 2) an electronic compass, and 3) a global positioning satellite tracking device;
a hemispheric imaging device operable to capture image data, the imaging device linked to at least one of 1) the main fusion server wherein the transmitted image data is preserved in its original state or 2) the imaging device is simultaneously linked to a sensor board and to the main fusion server.

2. The system of claim 1, wherein the main fusion server collects data from all devices in the networked system.

3. The networked system of claim 2, wherein the main fusion server fuses all of the information for intelligence development providing total situational awareness.

4. The networked system of claim 2, wherein the main fusion server is programmed with rules and transmits instructions to each device in the network.

5. The networked system of claim 2, wherein the main fusion server archives data for long term data storage and recall as needed.

6. The networked system of claim 1, wherein the archiving of data and the spatial coordinates and/or trajectory of the object are transmitted to one or more devices on the network.

7. The networked system of claim 1, wherein instant on-site alarming is provided without disrupting existing recording systems.
